(19) United States
(12) Patent Application Publication
(10) Pub. No.: US 2017/0297164 A1
(43) Pub. Date: Oct. 19, 2017

(54) CLEANING APPARATUS AND SUBSTRATE PROCESSING SYSTEM INCLUDING THE SAME

(71) Applicant: Samsung Electronics Co., Ltd., Suwon-si (KR)

(72) Inventors: Tae-Hong KIM, Seoul (KR); Jung-Min OH, Incheon (KR); SeokHoon KIM, Seongnam-si (KR); Chae Lyoung KIM, Hwaseong-si (KR); Mihyun PARK, Seongnam-si (KR); Hyosan LEE, Hwaseong-si (KR)

(73) Assignee: Samsung Electronics Co., Ltd., Suwon-si (KR)

(21) Appl. No.: 15/407,569

(22) Filed: Jan. 17, 2017

(30) Foreign Application Priority Data
Apr. 15, 2016 (KR) 10-2016-0045911

(51) Int. Cl. B24B 37/20; B08B 3/08; B08B 3/02; B24B 37/005; B05D 1/00

(52) U.S. Cl. CPC B24B 37/20; B24B 37/005; B05D 1/60; B08B 3/024; B08B 3/08

(57) ABSTRACT

Aspects of the inventive concepts provide a cleaning apparatus and a substrate processing system including the same. The cleaning apparatus includes a chuck receiving a substrate, a first nozzle providing first cleaning water or a first organic solvent onto the substrate at a first pressure, and a second nozzle disposed adjacent to the first nozzle. The second nozzle provides a cleaning solution including second cleaning water and a second organic solvent onto the substrate at a second pressure lower than the first pressure.

### CROSS-REFERENCE TO RELATED APPLICATION

This U.S. non-provisional patent application claims priority under 35 U.S.C. §119 to Korean Patent Application No. 10-2016-0045911, filed on Apr. 15, 2016, in the Korean Intellectual Property Office, the disclosure of which is hereby incorporated by reference in its entirety.

### BACKGROUND

Example embodiments of the inventive concepts relate to a substrate processing system and, more particularly, to a cleaning apparatus removing particles on a substrate or a substrate processing system including the same.

A semiconductor device may be fabricated by a plurality of unit processes. The unit processes may include a deposition process of a thin layer, a chemical mechanical polishing process, a photolithography process, an etching process, an ion implantation process, and a cleaning process. The cleaning process is a unit process for mainly removing particles existing on a substrate. Particles may be mainly removed by a water-based cleaning solution.

### SUMMARY

Embodiments of the inventive concepts may provide a cleaning apparatus capable of improving a cleaning efficiency.

Embodiments of the inventive concepts may also provide a cleaning apparatus capable of preventing occurrence of water mark stains and a substrate processing system including the same.

In one embodiment, a cleaning apparatus may comprise a chuck receiving a substrate, a first nozzle configured to provide a first cleaning water or a first organic solvent onto the substrate at a first pressure, and a second nozzle disposed adjacent to the first nozzle. The second nozzle may be configured to provide a cleaning solution including second cleaning water and a second organic solvent onto the substrate at a second pressure lower than the first pressure.

In one embodiment, a substrate processing system may comprise a deposition apparatus configured to deposit a thin layer on a substrate, and a cleaning apparatus configured to remove at least one particle on the thin layer. The cleaning apparatus may include a chuck receiving the substrate, a first nozzle configured to provide a first cleaning water or a first organic solvent onto the thin layer at a first pressure, and a second nozzle disposed adjacent to the first nozzle. The second nozzle may be configured to provide a cleaning solution including second cleaning water and a second organic solvent onto the thin layer at a second pressure lower than the first pressure.

In one embodiment, a cleaning apparatus may comprise a chuck configured to receive a substrate, a nozzle configured to provide a cleaning solution including a cleaning water onto the substrate, a detector configured to detect an image of the cleaning solution on the substrate, and a controller configured to determine a contact angle of the cleaning solution on the substrate and configured to adjust a mixture ratio of the organic solvent to the cleaning water in the cleaning solution based on the contact angle.

### BRIEF DESCRIPTION OF THE DRAWINGS

The inventive concepts will become more apparent in view of the attached drawings and accompanying detailed description.

FIG. 1 is a schematic view illustrating a substrate processing system according to some embodiments of the inventive concepts.

FIG. 2 is a schematic view illustrating an example embodiment of a deposition apparatus of FIG. 1.

FIG. 3 is a schematic view illustrating an example embodiment of a cleaning apparatus of FIG. 1.

FIG. 4 is a schematic view illustrating first and second nozzles of FIG. 3.

FIG. 5 is a cross-sectional view illustrating an embodiment of the first nozzle of FIG. 4.

FIG. 6 is a graph illustrating first to third removal rates according to a size of a particle of FIG. 4.

FIG. 7 is an image illustrating water mark stains on a thin layer of FIG. 3.

FIG. 8 is a cross-sectional view schematically illustrating a contact angle of a drop of a second cleaning solution illustrated in FIG. 3.

FIG. 9 is a graph illustrating a variation in contact angle of a drop according to a mixture ratio of a second organic solvent and second cleaning water of FIG. 3.

FIG. 10 is a flow chart illustrating a method of cleaning a substrate by using the cleaning apparatus of FIG. 3.

FIG. 11 is a schematic view illustrating a substrate processing system according to some example embodiments of the inventive concepts.

FIG. 12 is a schematic view illustrating an example embodiment of a polishing apparatus of FIG. 11.

### DETAILED DESCRIPTION OF THE EMBODIMENTS

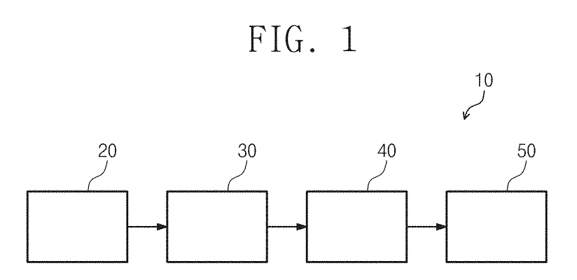

FIG. 1 illustrates a substrate processing system 10 according to some embodiments of the inventive concepts.

Referring to FIG. 1, a substrate processing system 10 may include a deposition apparatus 20, a cleaning apparatus 30, a photolithography apparatus 40, and an etching apparatus 50. The deposition apparatus 20 may deposit a thin layer on a substrate. The cleaning apparatus 30 may clean the thin layer deposited on the substrate. The photolithography apparatus 40 may form a photoresist pattern (not shown) on the thin layer. The etching apparatus 50 may etch the thin layer using the photoresist pattern as an etch mask to form a thin-layer pattern. Thereafter, the photoresist pattern may be removed. Fabrication processes performed using the apparatuses 20 to 50 may be repeatedly performed on the substrate, or may be performed in various orders or with additional unit processes not limited to those above.

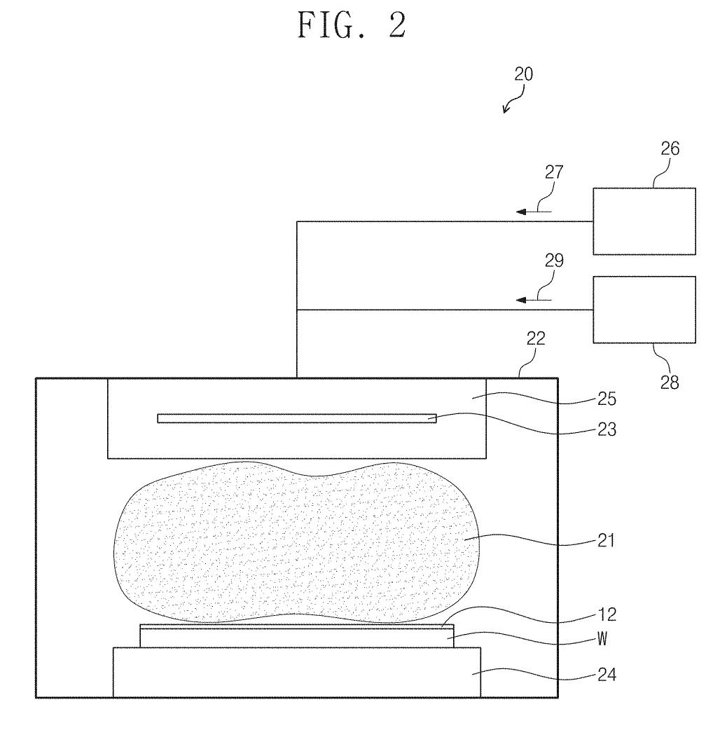

FIG. 2 illustrates an example embodiment of the deposition apparatus 20 of FIG. 1.

Referring to FIG. 2, the deposition apparatus 20 may include, for example, a vapor deposition apparatus such as a chemical vapor deposition (CVD) apparatus. For example, the deposition apparatus 20 may include a metal-organic chemical vapor deposition (MOCVD) apparatus. Alternatively, the deposition apparatus 20 may include a plasma-enhanced chemical vapor deposition (PECVD) apparatus. In some embodiments, the deposition apparatus 20 may include a first chamber 22, a susceptor 24, a shower head 25, and first and second reaction gas supply parts 26 and 28.

The first chamber 22 may provide a space which is independent of an outside of the first chamber 22 and into which a substrate W is provided. For example, the first chamber 22 may have a vacuum pressure of about 10−3 Torr to about 10−2 Torr.

The susceptor 24 may be disposed in the first chamber 22, e.g., in a lower region of the space of the first chamber 22. The susceptor 24 may receive the substrate W. The substrate W may be heated to a high temperature. For example, the substrate W may be heated to a temperature of about 200 degrees Celsius or more.

The shower head 25 may be disposed in the first chamber 22, e.g., in an upper region of the space of the first chamber 22. The shower head 25 may provide first and second reaction gases 27 and 29 onto the substrate W. A plasma electrode 23 may be disposed in the shower head 25. The plasma electrode 23 may induce plasma 21 by using high-frequency power. The plasma 21 may include the first and second reaction gases 27 and 29 which are activated between the susceptor 24 and the shower head 25 by the high-frequency power.

The first and second reaction gas supply parts 26 and 28 may supply the first and second reaction gases 27 and 29 into the first chamber 22. For example, the first reaction gas 27 may include a silane (SiH₄) gas. The second reaction gas 29 may include a methane (CH₄) gas. A thin layer 12 may be formed on the substrate W in the first chamber 22 by using the first reaction gas 27 and the second reaction gas 29. In some embodiments, the thin layer 12 may be a low-k dielectric layer of which a dielectric constant is lower than that of a silicon oxide (SiO₂) layer. For example, the thin layer 12 may include a silicon carbide (SiC) layer, a silicon oxycarbide (SiOC) layer, or a silicon oxycarbonitride (SiOCN) layer. The thin layer 12 may mainly reduce a coupling capacitance between electrical interconnection lines. The thin layer 12 may have a hydrophobic property. After the formation of the thin layer 12, the first reaction gas 27 and the second reaction gas 29 may generate a post-reaction gas (e.g., a by-product gas). For example, the post-reaction gas may include a hydrogen gas. The post-reaction gas may be exhausted to the outside of the first chamber 22 by a vacuum pump.

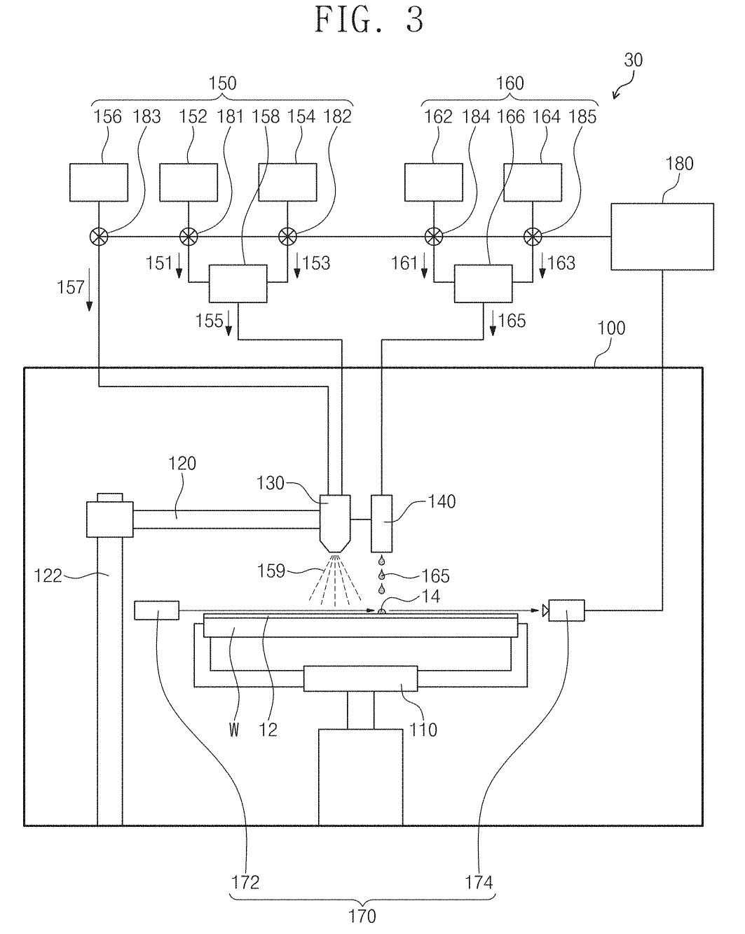

FIG. 3 illustrates example embodiment of the cleaning apparatus 30 of FIG. 1.

Referring to FIG. 3, the cleaning apparatus 30 may be a deionized-water-based cleaning apparatus. In some embodiments, the cleaning apparatus 30 may include a second chamber 100, a chuck 110, an arm 120, first and second nozzles 130 and 140, first and second cleaning fluid supply parts 150 and 160, a cleaning solution detector 170, and a controller 180. The chuck 110, the arm 120, the first and second nozzles 130 and 140, and the cleaning solution detector 170 may be disposed in the second chamber 100. The chuck 110 may receive the substrate W. The arm 120 may provide the first and second nozzles 130 and 140 over the substrate W. The first and second nozzles 130 and 140 may respectively provide first and second cleaning fluids 159 and 165 onto the thin layer 12 of the substrate W. The first and second cleaning fluid supply parts 150 and 160 may provide the first cleaning fluid 159 and the second cleaning fluid 165 into the first nozzle 130 and the second nozzle 140, respectively. In some embodiments, the first cleaning fluid 159 may include a first cleaning solution and a carrier gas as described later, and the second cleaning fluid 165 may be a second cleaning solution 165. The cleaning solution detector 170 may detect an image of the second cleaning solution 165. The controller 180 may check a contact angle of the second cleaning solution 165 from the detected image to adjust wettability of the second cleaning solution 165 with respect to the thin layer 12.

The second chamber 100 may be a housing surrounding the chamber 110. The second chamber 100 may reduce or prevent external exhaust of the first cleaning fluid 159 and the second cleaning solution 165. The first cleaning fluid 159 and the second cleaning solution 165 on the substrate W may be collected to a scrubber (not shown) disposed under the second chamber 100.

The chuck 110 may clamp the substrate W. In addition, the chuck 110 may rotate the substrate W. For example, the chuck 110 may rotate the substrate W at a rotational speed of about 60 rpm to about 1000 rpm.

The arm 120 may be disposed between a shaft 122 and the first and second nozzles 130 and 140. One end of the arm 120 may be connected to the shaft 122, and another end of the arm 120 may be connected to the first and second nozzles 130 and 140. The shaft 122 may be fixed outside the chuck 110 and the substrate W. The shaft 122 may rotate the arm 120 and the first and second nozzles 130 and 140. The first and second nozzles 130 and 140 may be movable in a radial direction of the substrate W. The first cleaning fluid 159 and the second cleaning solution 165 may be provided to an entire top surface of the thin layer 12 by the rotation of the shaft 122 and the chuck 110. For example, the first and second nozzles 130 and 140 may provide the first cleaning fluid 159 and the second cleaning solution 165 while moving at a speed of about 5 mm/sec to about 50 mm/sec by the arm 120 and the shaft 122.

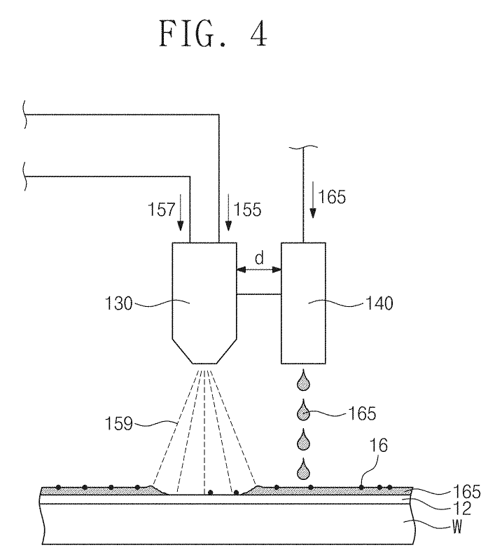

FIG. 4 illustrates the first and second nozzles 130 and 140 of FIG. 3.

Referring to FIG. 4, the first and second nozzles 130 and 140 may provide the first cleaning fluid 159 and the second cleaning fluid 165 (i.e., the second cleaning solution 165) onto the thin layer 12 at the same time. A pressure of the first cleaning fluid 159 may be higher than a pressure of the second cleaning solution 165.

The first nozzle 130 may be a spray nozzle. The first cleaning fluid 159 may separate particles 16 from the thin layer 12. For example, the particles 16 may include carbon or polymer included in the thin layer 12. The first cleaning fluid 159 may include a first cleaning solution 155 and a carrier gas 157, as described above. In some embodiments, the first cleaning solution 155 may dissolve the particles 16. Alternatively, the first cleaning solution 155 may have a high pressure and may impact on the particles 16. The particles 16 may be separated from the thin layer 12 by pressure and impact force of the first cleaning fluid 159. The carrier gas 157 may accelerate the first cleaning solution 155. For example, the carrier gas 157 may include a nitrogen (N₂) gas.

Referring to FIGS. 3 and 4, the first cleaning solution 155 may include first cleaning water 151 and a first organic solvent 153. The first cleaning water 151 may include deionized water, ammonia water, a surfactant, oxygenated water, or a standard cleaning 1 (SC1) solution (NH₄OH:H₂O₂:H₂O). The first organic solvent 153 may dissolve a carbon-based organic material (not shown) on the thin layer 12. For example, the first organic solvent 153 may include isopropyl alcohol. The first cleaning water 151 and the first organic solvent 153 may evaporate by the carrier gas 157. Alternatively, the first cleaning water 151 and the first organic solvent 153 may remain on the thin layer 12.

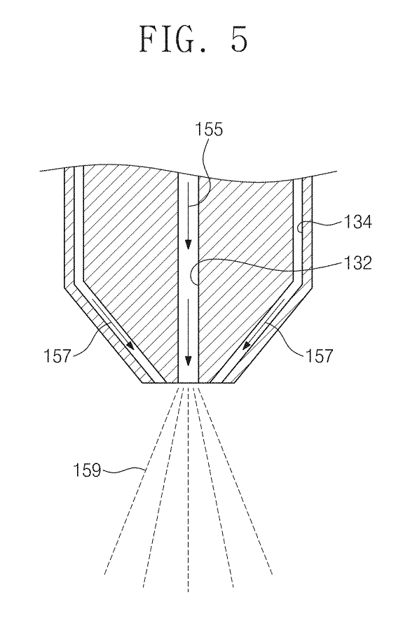

FIG. 5 illustrates an example embodiment of the first nozzle 130 of FIG. 4.

Referring to FIG. 5, the first nozzle 130 may have an internal hole 132 and an external hole 134. The first cleaning solution 155 may be provided into the internal hole 132. The first cleaning solution 155 may have a pressure of about 3 bar. The first cleaning solution 155 may be provided at a flow rate of about 5 cc/min to about 100 cc/min. The carrier gas 157 may be provided into the external hole 134. The carrier gas 157 may have a pressure of about 2 bar to about 10 bar. The carrier gas 157 may be provided at a flow rate of about 5,000 cc/min to about 500,000 cc/min. The carrier gas 157 may atomize the first cleaning solution 155. The first cleaning fluid 159 may be provided at a pressure of about 7 bar to about 10 bar onto the thin layer 12.

Referring again to FIG. 4, the second nozzle 140 may be disposed adjacent to the first nozzle 130. The first nozzle 130 may be disposed between the arm 120 and the second nozzle 140. The second nozzle 140 may be fixed at a distance d of about 5 cm to about 10 cm from the first nozzle 130. In some embodiments, the second nozzle 140 may drop or supply the second cleaning solution 165 onto the thin layer 12. The second nozzle 140 may drop or supply the second cleaning solution 165 at a normal pressure. The second cleaning solution 165 may he dropped at a flow rate of about 1.0 cc/min to about 800 cc/min. The dropped second cleaning solution 165 may float the particles 16. Alternatively, the dropped second cleaning solution 165 may be mixed with the first cleaning solution 155 of the first cleaning fluid 159, and thus a mixture cleaning solution may be generated. The first and second cleaning solutions 155 and 165 mixed with each other may float the particles 16 from the thin layer 12. The floated particles 16 and the first and second cleaning solutions 155 and 165 may be removed by rotation of the substrate W. As a result, a cleaning efficiency may be increased or maximized.

The second cleaning solution 165 may include second cleaning water 161 and a second organic solvent 163. The second cleaning water 161 may be the same as the first cleaning water 151. For example, the second cleaning water 161 may include deionized water, ammonia water, a surfactant, oxygenated water, or a standard cleaning 1 (SC1) solution (NH4OH:H2O2:H2O). The second organic solvent 163 may be the same as the first organic solvent 153. For example, the second organic solvent 163 may include isopropyl alcohol.

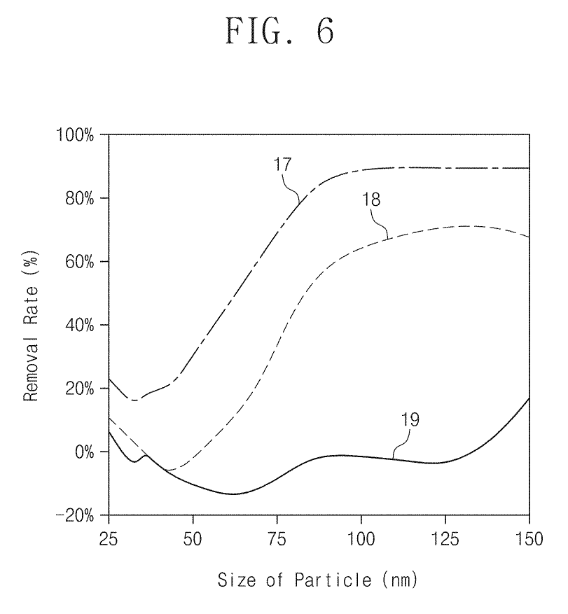

FIG. 6 illustrates first to third removal rates 17 to 19 according to a size of the particle 16 of FIG. 4.

Referring to FIG. 6, the first removal rate 17 of the second cleaning water 161 may be higher than the third removal rate 19 of the second organic solvent 163. This may be because the particles 16 are floated more easily by the second cleaning water 161 than by the second organic solvent 163. The second removal rate 18 of the second cleaning solution 165 may be between the first and third removal rates 17 and 19. The particles 16 may be removed more easily by the second cleaning solution 165 including the second organic solvent 163 and the second cleaning water 161 than by the second organic solvent 163 alone. On the other hand, the particles 16 may be removed more easily by the second cleaning water 161 than by the second cleaning solution 165 in which the second organic solvent 163 and the second cleaning water 161 are mixed with each other. Thus, when a mixture ratio of the second organic solvent 163 to the second cleaning water 161 increases in the second cleaning solution 165, the removal rate of the particles 16 may be reduced.

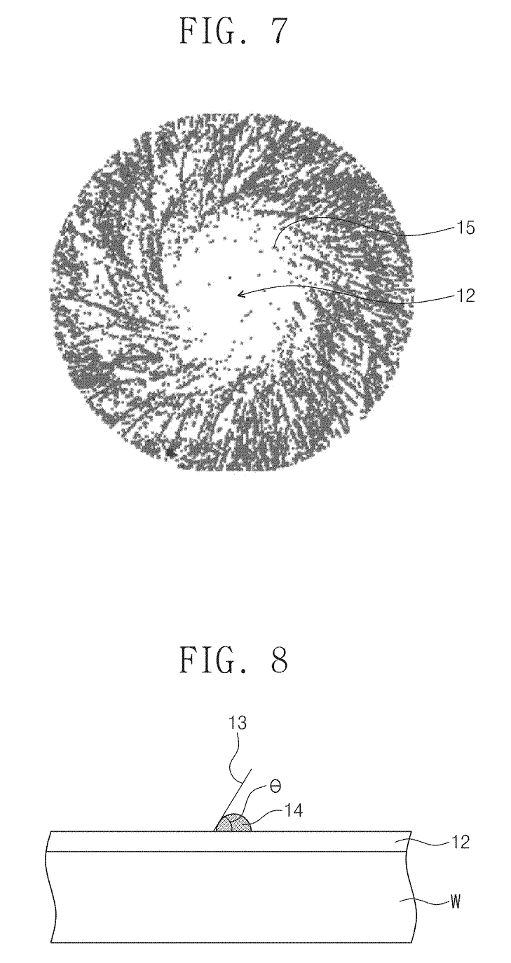

FIG. 7 illustrates water mark stains 15 on the thin layer 12 of FIG. 3. FIG. 8 illustrates a contact angle θ of a drop 14 of the second cleaning solution 165 illustrated in FIG. 3.

Referring to FIGS. 7 and 8, when the mixture ratio of the second organic solvent 163 to the second cleaning water 161 is reduced, in the second cleaning solution 165, the second cleaning solution 165 may cause a drying defect. For example, the second cleaning water 161 may cause water mark stains 15 on the thin layer 12 in or after a drying process. When the mixture ratio of the second organic solvent 163 to the second cleaning water 161 is equal to or lower than 1:1, the water mark stains 15 may occur. The water mark stains 15 may have a spiroidial shape. The second cleaning water 161 may be scattered in a spiroidial shape of a rotation direction of the chuck 110. The second cleaning water 161 may be adhered onto the thin layer 12 in a drop form (see 14 of FIG. 3). The adhered drops 14 may cause the water mark stains 15 in the drying process.

When the mixture ratio of the second organic solvent 163 to the second cleaning water 161 increases, the drops 14 may be removed from the thin layer 12 without the water mark stains 15. The second organic solvent 163 may increase wettability of the second cleaning solution 165 with respect to the thin layer 12. When the wettability is increased, the second cleaning solution 165 may slide on the thin layer 12 without adhesion of the drops 14. As a result, the wettability of the second cleaning solution 165 may be increased to reduce the water mark stains 15.

Referring to FIGS. 3, 7, and 8, the cleaning solution detector 170 may include a light source 172 and a sensor 174. In some embodiments, the second nozzle 140 may drop the second cleaning solution 165 between the light source 172 and the sensor 174. The light source 172 may provide light 171 to the drop 14. For example, the light 171 may be visible light or infrared light. The light 171 may project the drop 14 to the sensor 174. The sensor 174 may detect an image of the projected drop 14. For example, the sensor 174 may detect a shadow image of the drop 14.

The controller 180 may determine a contact angle θ of the drop 14 from the detected image. The contact angle θ may be defined as an inclination angle from a top surface of the thin layer 12 to an extending line 13 of an edge of the drop 14. The contact angle θ may be inversely proportional to the wettability. In other words, as the contact angle θ is reduced, the wettability of the second cleaning solution 165 with respect to the substrate W may be increased. Contrariwise, as the contact angle θ increases, the wettability may be reduced. The contact angle θ may be proportional to an occurrence of the water mark stains 15. In other words, as the contact angle θ is reduced, the occurrence of the water mark stains 15 may be reduced. For example, when the contact angle θ is in a range of 0 degree to 30 degrees, the occurrence of the water mark stains 15 may be prevented.

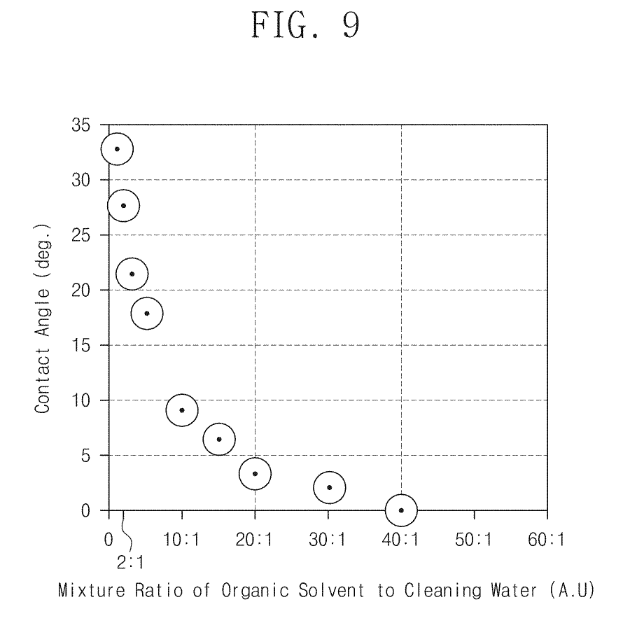

FIG. 9 is a graph illustrating a variation in contact angle of the drop 14 according to the mixture ratio of the second organic solvent 163 to the second cleaning water 161 of FIG. 3.

Referring to FIG. 9, when the mixture ratio of the second organic solvent 163 to the second cleaning water 161 increases, the contact angle θ may be reduced. For example, when the mixture ratio is 1:1, the contact angle θ may be about 33 degrees. In this case, the water mark stains 15 may occur. When the mixture ratio is 2:1, the contact angle θ may be about 28 degrees. When the mixture ratio is 40:1, the contact angle θ may be about 0 degrees. As the mixture ratio of the second organic solvent 163 to the second cleaning water 161 increases from 2:1 to 40:1, the contact angle θ of the drop 14 of the second cleaning solution 165 may be gradually reduced. In these cases, the water mark stains 15 may hardly occur.

Referring again to FIG. 3, the controller 180 may control the first and second cleaning fluid supply parts 150 and 160.

The first cleaning fluid supply part 150 may be connected to the first nozzle 130. In some embodiments, the first cleaning fluid supply part 150 may include a first cleaning water tank 152, a first organic solvent tank 154, a carrier gas tank 156, a first mixer 158, and first to third valves 181 to 183. The first cleaning water tank 152 may store the first cleaning water 151. The first valve 181 may be connected between the first cleaning water tank 152 and the first nozzle 130. The first valve 181 may adjust a supply flow rate of the first cleaning water 151. The first organic solvent tank 154 may store the first organic solvent 153. The second valve 182 may be connected between the first organic solvent tank 154 and the first nozzle 130. The second valve 182 may adjust a supply flow rate of the first organic solvent 153. The first mixer 158 may be connected between the first nozzle 130 and the first and second valves 181 and 182. The first mixer 158 may mix the first cleaning water 151 and the first organic solvent 153 with each other to provide the first cleaning solution 155 into the first nozzle 130. The carrier gas tank 156 may store the carrier gas 157. The third valve 183 may be connected between the carrier gas tank 156 and the first nozzle 130. The third valve 183 may adjust a supply flow rate of the carrier gas 157. The controller 180 may be connected to the first to third valves 181 to 183. The controller 180 may control the flow rate and the pressure of the first cleaning fluid 159. The controller 180 may adjust the mixture ratio of the first organic solvent 153 and the first cleaning water 151.

The second cleaning fluid supply part 160 may be connected to the second nozzle 140. In sonic embodiments, the second cleaning fluid supply part 160 may include a second cleaning water tank 162, a second organic solvent tank 164, a second mixer 166, and fourth and fifth valves 184 and 185. The second cleaning water tank 162 may store the second cleaning water 161. The fourth valve 184 may be connected between the second cleaning water tank 162 and the second nozzle 140. The fourth valve 184 may adjust a supply flow rate of the second cleaning water 161. The second organic solvent tank 164 may store the second organic solvent 163. The fifth valve 185 may be connected between the second organic solvent tank 164 and the second nozzle 140. The fifth valve 185 may adjust a flow rate of the second organic solvent 163. The second mixer 166 may be connected between the second nozzle 140 and the fourth and fifth valves 184 and 185. The second mixer 166 may mix the second cleaning water 161 and the second organic solvent 163 with each other to provide the second cleaning solution 165 into the second nozzle 140. The fourth and fifth valves 184 and 185 may be connected to the controller 180. In some embodiments, the controller 180 may adjust the mixture ratio of the second organic solvent 163 to the second cleaning water 161 on the basis of the contact angle θ of the drop 14 of the second cleaning solution 165. For example, the controller 180 may adjust the mixture ratio of the second organic solvent 163 to the second cleaning water 161 in a range of 2:1 to 40:1, thereby preventing the occurrence of the water mark stains 15. In certain embodiments, the controller 180 may adjust the mixture ratios of the first and second organic solvents 153 and 163 to the first and second cleaning waters 151 and 161 in the range of 2:1 to 40:1, thereby preventing the occurrence of the water mark stains 15. Hereinafter, a method of cleaning the substrate W will be described.

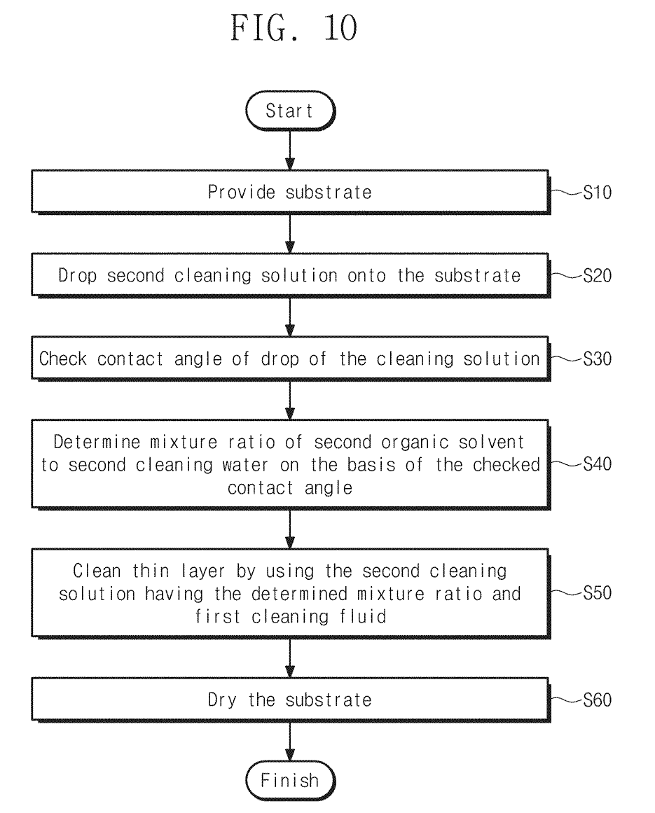

FIG. 10 is a flow chart illustrating a method of cleaning a substrate by using the cleaning apparatus 30 of FIG. 3.

Referring to FIG. 10, a cleaning method may include providing the substrate W having the thin layer 12 into the second chamber 100 (S10), dropping the drop 14 of the second cleaning solution 165 onto the thin layer 12 (S20), checking the contact angle θ of the drop 14 (S30), determining the mixture ratio of the second organic solvent 163 to the second cleaning water 161 in the second cleaning solution 165 on the basis of the checked contact angle θ (S40), cleaning the thin layer 12 and the substrate W by using the second cleaning solution 165 having the determined mixture ratio and the first cleaning fluid 159 (S50), and drying the substrate W (S60).

FIG. 11 illustrates a substrate processing system 10a according to some embodiments of the inventive concepts.

Referring to FIG. 11, a substrate processing system 10a may further include a polishing apparatus 60 disposed between a deposition apparatus 20 and a cleaning apparatus 30. The polishing apparatus 60 may polish the thin layer 12 of the substrate W. The deposition apparatus 20, the cleaning apparatus 30, a photolithography apparatus 40, and an etching apparatus 50 may be the same as described with reference to FIG. 1.

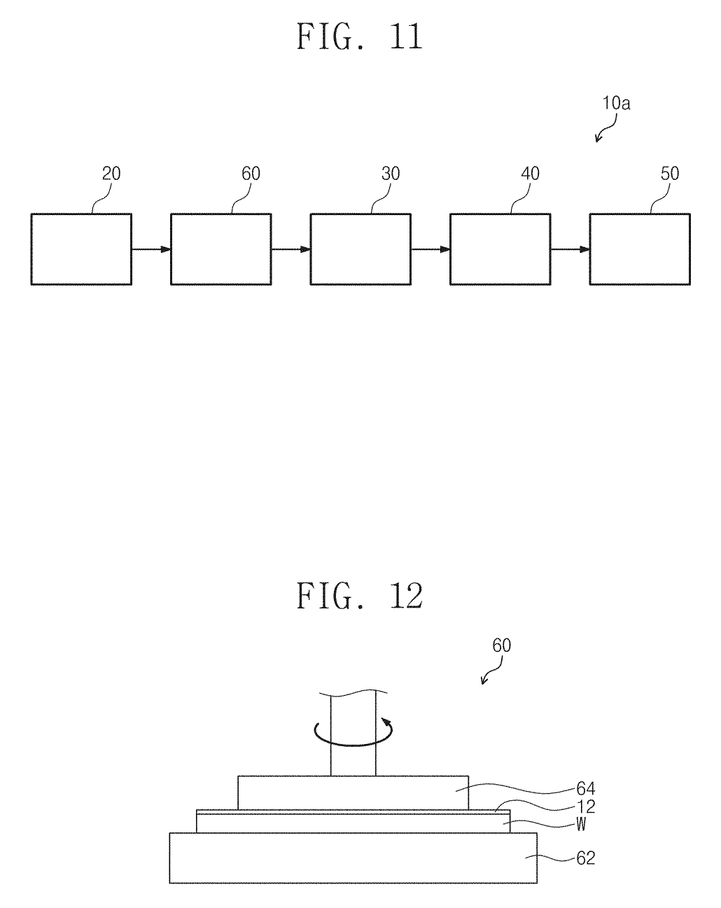

FIG. 12 illustrates an example embodiment of the polishing apparatus 60 of FIG. 11.

Referring to FIG. 12, the polishing apparatus 60 may he a chemical mechanical polishing apparatus. For example, the polishing apparatus 60 may include a chuck table 62 and a polishing pad 64. The substrate W may be provided between the chuck table 62 and the polishing pad 64. The chuck table 62 may fix the substrate W. The polishing pad 64 may be rotatable. The polishing pad 64 may polish the thin layer 12 of the substrate W. Thus, the thin layer 12 may be flattened.

Referring again to FIGS. 3 and 8, the flattened thin layer 12 may increase or improve reliability of the detection of the contact angle θ of the drop 14 of the second cleaning solution 165.

As described above, the cleaning apparatus according to some embodiments of the inventive concepts may include the first and second nozzles fixed on one arm. The pressure of the cleaning fluid provided onto the substrate by the first nozzle may be higher than the pressure of the cleaning solution provided onto the substrate by the second nozzle. The cleaning fluid of the first nozzle may separate the particles from the substrate by the pressure and the impact force, and the cleaning solution of the second nozzle may float the separated particles by etching or electrical repulsive force. Adhesive force of the floated particles may be reduced, and thus the floated particles may be easily removed by the rotation of the substrate or may be easily removed by the pressure of the first nozzle even though the pressure of the first nozzle is low. Thus, the cleaning efficiency of the cleaning apparatus may be improved. The cleaning solution may include the organic solvent and the cleaning water. The cleaning water may float the particles. The organic solvent may be mixed with the cleaning water to increase the wettability of the cleaning solution with respect to the substrate. The mixed organic solvent may prevent the occurrence of the watermark stains of the cleaning water.

While the inventive concepts have been described with reference to example embodiments, it will be apparent to those skilled in the art that various changes and modifications may be made without departing from the spirits and scopes of the inventive concepts. Therefore, it should be understood that the above embodiments are not limiting, but illustrative. Thus, the scopes of the inventive concepts are to be determined by the broadest permissible interpretation of the following claims and their equivalents, and shall not be restricted or limited by the foregoing description.

What is claimed is:

1. A cleaning apparatus comprising:
a chuck receiving a substrate;
a first nozzle configured to provide a first cleaning water or a first organic solvent onto the substrate at a first pressure; and
a second nozzle disposed adjacent to the first nozzle, the second nozzle configured to provide a cleaning solution including second cleaning water and a second organic solvent onto the substrate at a second pressure lower than the first pressure.

2. The cleaning apparatus of claim 1, further comprising:
a detector disposed adjacent to the chuck, the detector configured to detect an image of the cleaning solution on the substrate; and
a controller configured to determine a contact angle of the cleaning solution with respect to the substrate from the detected image, the controller configured to adjust a mixture ratio of the second organic solvent to the second cleaning water in the cleaning solution on the basis of the contact angle.

3. The cleaning apparatus of claim 2, wherein the controller is configured to adjust the mixture ratio of the second organic solvent to the second cleaning water in such a way that the mixture ratio is inversely proportional to the contact angle.

4. The cleaning apparatus of claim 2, wherein the mixture ratio of the second organic solvent to the second cleaning water is in a range of 2:1 to 40:1 when the contact angle is in a range of 0 degree to 30 degrees.

5. The cleaning apparatus of claim 2, wherein the detector comprises:
a light source configured to provide light to the cleaning solution; and
a sensor configured to detect the image of the cleaning solution by the light,
wherein the second nozzle is configured to provide the cleaning solution onto the substrate between the light source and the sensor.

6. The cleaning apparatus of claim 2, further comprising:
a first cleaning fluid supply part configured to supply the first cleaning water or the first organic solvent into the first nozzle, the first cleaning fluid supply part configured to provide a carrier gas mixing with the first cleaning water or the first organic solvent into the first nozzle; and
a second cleaning fluid supply part configured to supply the second cleaning water and the second organic solvent into the second nozzle.

7. The cleaning apparatus of claim 6, wherein the first and second cleaning fluid supply parts comprise:
a plurality of tanks configured to store the first and second cleaning waters and the first and second organic solvents; and
a plurality of valves between the plurality of tanks and the first and second nozzles,
wherein the controller is configured to control the plurality of valves.

8. The cleaning apparatus of claim 1, further comprising:
a controller configured to adjust a mixture ratio of the second organic solvent to the second cleaning water according to a contact angle of a drop of the cleaning solution on the substrate.

9. The leaning apparatus of claim 8, wherein the contact angle is less than or equal to 30 degrees, and
wherein the mixture ratio of the second organic solvent to the second cleaning water is in a range of 2:1 to 40:1.

10. The cleaning apparatus of claim 1, wherein each of the first and second cleaning waters includes deionized water, ammonia water, a surfactant, oxygenated water, or a standard cleaning 1 (SC1) solution, and
wherein each of the first and second organic solvents includes isopropyl alcohol.

11. A substrate processing system comprising:
a deposition apparatus configured to deposit a thin layer on a substrate; and
a cleaning apparatus configured to remove at least one particle on the thin layer,
wherein the cleaning apparatus includes,
a chuck configured to receive the substrate,
a first nozzle configured to provide a first cleaning water or a first organic solvent onto the thin layer at a first pressure, and
a second nozzle disposed adjacent to the first nozzle, the second nozzle configured to provide a cleaning solution including second cleaning water and a second organic solvent onto the thin layer at a second pressure lower than the first pressure.

12. The substrate processing system of claim 11, wherein the deposition apparatus is a metal-organic chemical vapor deposition (MOCVD) apparatus.

13. The substrate processing system of claim 11, wherein the thin layer has a hydrophobic property with respect to the first and second cleaning waters.

14. The substrate processing system of claim 11, wherein the thin layer includes a silicon carbide (SiC) layer, a silicon oxycarbide (SiOC) layer, or a silicon oxycarbonitride (SiOCN) layer.

15. The substrate processing system of claim 11, further comprising:
a chemical mechanical polishing apparatus disposed between the deposition apparatus and the cleaning apparatus.

16. A cleaning apparatus comprising:
a chuck configured to receive a substrate;
a nozzle configured to provide a cleaning solution including a cleaning water and an organic solvent onto the substrate;
a detector configured to detect an image of the cleaning solution on the substrate; and
a controller configured to determine a contact angle of the cleaning solution on the substrate from the image and configured to adjust a mixture ratio of the organic solvent to the cleaning water in the cleaning solution based on the contact angle.

17. The cleaning apparatus of claim 16, wherein the detector includes a light source and a sensor.

18. The cleaning apparatus of claim 17, where the light source includes a light source of visible or infrared light.

19. The cleaning apparatus of claim 17, where the controller is configured to determine the contact angle based on a shadow image of a drop of the cleaning solution on the image.

20. The cleaning apparatus of claim 16, wherein the controller is configured to adjust the mixture ratio of the organic solvent to the cleaning water in such a way that the mixture ratio is inversely proportional to the contact angle.
